(19) United States
(12) Patent Application Publication
(10) Pub. No.: US 2012/0005459 A1
(43) Pub. Date: Jan. 5, 2012

(54) PROCESSOR HAVING INCREASED PERFORMANCE AND ENERGY SAVING VIA MOVE ELIMINATION

(75) Inventors: Jay FLEISCHMAN, Ft. Collins, CO (US); Matthew M. CRUM, Austin, TX (US); Michael ESTLICK, Ft. Collins, CO (US); Ranganathan SUDHAKAR, Santa Clara, CA (US); Emil TALPES, Sunnyvale, CA (US); Ganesh VENKATARAMANAN, Sunnyvale, CA (US); Barry J. Arnold, (US); Michael Sedmak, (US)

(73) Assignee: ADVANCED MICRO DEVICES, INC., Sunnyvale, CA (US)

(21) Appl. No.: 12/979,948

(22) Filed: Dec. 28, 2010

Related U.S. Application Data
(63) Continuation-in-part of application No. 10/896,607, filed on Jul. 22, 2004, now Pat. No. 7,427,505.

(51) Int. Cl. G06F 9/30

(52) U.S. Cl. 712/216; 712/E09.023

(57) ABSTRACT

Methods and apparatuses are provided for increasing processor performance and energy saving via eliminating physical data movement to accomplish a move instruction. The apparatus comprises a first plurality of available physical registers mapped to a second plurality of logical registers, including a source logical register and a destination logical register. A renaming unit remaps the destination logical register to the same physical register mapping as the source logical register in response to a move instruction. In this way, the move instruction is effectively executed without moving data between physical registers. A method is provided for increasing processor performance and energy saving via eliminating physical data movement to accomplish a move instruction. The method comprises determining a mapping of a logical source register and a logical destination register to physical registers of a processor and then remapping the logical destination register to the same physical register mapping as the logical source register to affect an equivalent of the move instruction with actual data movement between physical registers.

### FIELD OF THE INVENTION

The present invention relates to the field of information or data processor architecture. More specifically, this invention relates to the field of logical to physical register remapping.

### BACKGROUND

In any processor architecture, there exists a limited number of physical registers for storing instructions and data. Generally a data move operation reads a value out of one physical register (known as the source register) and writes that value into a second physical register (known as the destination register). Data move operations are common during floating-point or integer computations, and moving a value from one register to another register consumes operational cycles of the processor as well as power. Moreover, a data move operation is typically a scheduled task within a floating-point or integer unit, which prevents other instructions from being processed until the move is completed. Thus, each data move instruction, while necessary, reduces overall throughput and increases latency and power consumption in a processor or its operational units.

### BRIEF SUMMARY OF EMBODIMENTS OF THE INVENTION

An apparatus is provided for increasing processor performance and energy saving via eliminating physical data movement to accomplish a move instruction. The apparatus comprises a first plurality of available physical registers mapped to a second plurality of logical registers, including a source logical register and a destination logical register. A renaming unit remaps the destination logical register to the same physical register mapping as the source logical register in response to a move instruction. In this way, the move instruction is effectively executed without moving data between physical registers.

A method is provided for increasing processor performance and energy saving via eliminating physical data movement to accomplish a move instruction. The method comprises determining a mapping of a logical source register and a logical destination register to physical registers of a processor and then remapping the logical destination register to the same physical register mapping as the logical source register to affect an equivalent of the move instruction with actual data movement between physical registers.

### BRIEF DESCRIPTION OF THE DRAWINGS

The present invention will hereinafter be described in conjunction with the following drawing figures, wherein like numerals denote like elements, and

FIG. 1 is a simplified exemplary block diagram of processor suitable for use with the embodiments of the present disclosure;

FIG. 2 is a simplified exemplary block diagram of computational unit suitable for use with the processor of FIG. 1;

FIG. 3 simplified exemplary block diagram illustrating physical register data move elimination according to an embodiment of the present disclosure; and

FIG. 4 is a flow diagram illustrating physical register data move elimination according to an embodiment of the present disclosure.

### DETAILED DESCRIPTION OF THE INVENTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Moreover, as used herein, the word “processor” encompasses any type of information or data processor, including, without limitation, Internet access processors, Intranet access processors, personal data processors, military data processors, financial data processors, navigational processors, voice processors, music processors, video processors or any multimedia processors. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, the following detailed description or for any particular processor microarchitecture.

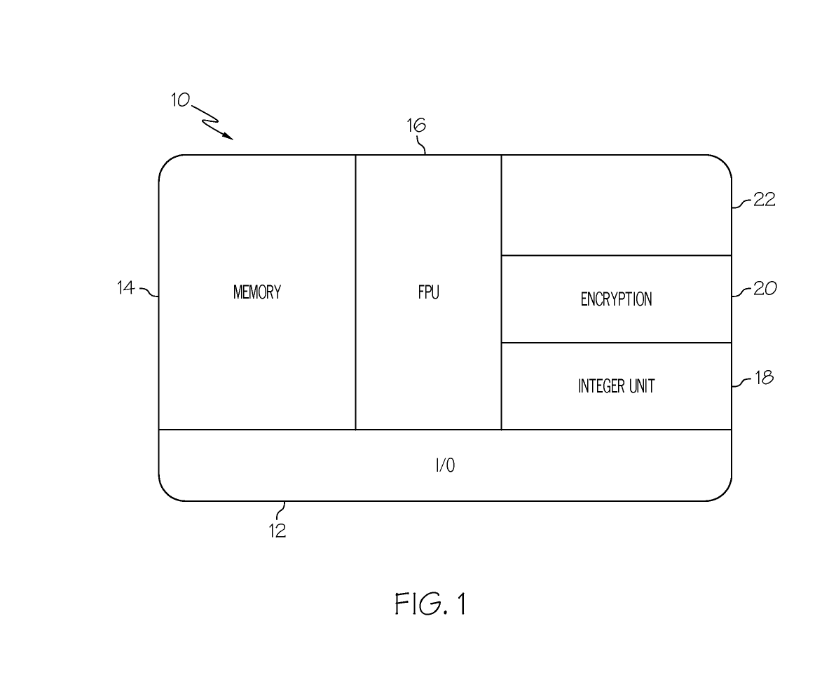

Referring now to FIG. 1, a simplified exemplary block diagram is shown illustrating a processor 10 suitable for use with the embodiments of the present disclosure. In some embodiments, the processor 10 would be realized as a single core in a large-scale integrated circuit (LSIC). In other embodiments, the processor 10 could be one of a dual or multiple core LSIC to provide additional functionality in a single LSIC package. As is typical, processor 10 includes an input/output (I/O) section 12 and a memory section 14. The memory 14 can be any type of suitable memory. This would include the various types of dynamic random access memory (DRAM) such as SDRAM, the various types of static RAM (SRAM), and the various types of non-volatile memory (PROM, EPROM, and flash). In certain embodiments, additional memory (not shown) “off chip” of the processor 10 can be accessed via the I/O section 12. The processor 10 may also include a floating-point unit (FPU) 16 that performs the float-point computations of the processor 10 and an integer processing unit 18 for performing integer computations. Additionally, an encryption unit 20 and various other types of units (generally 22) as desired for any particular processor microarchitecture may be included.

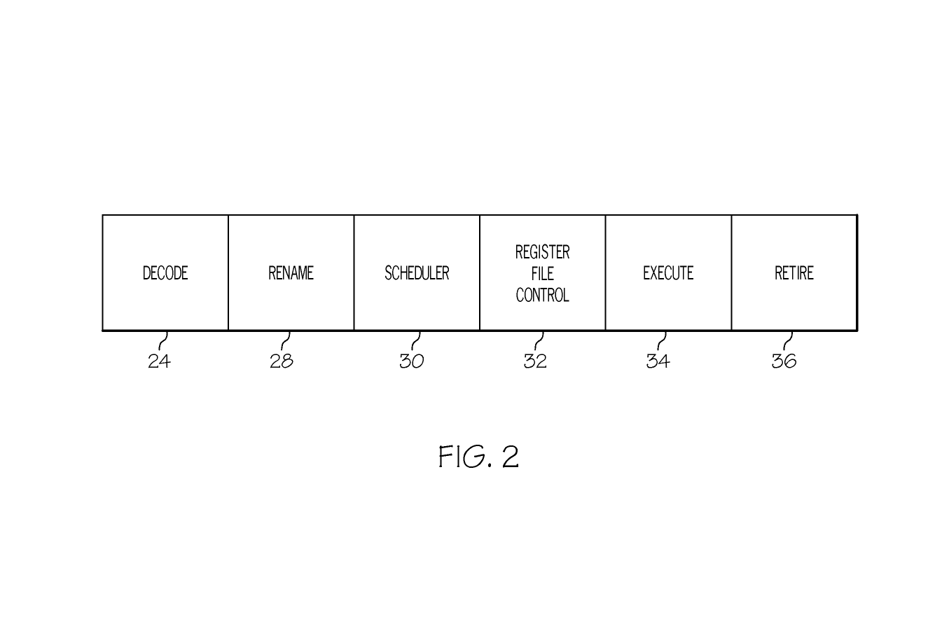

Referring now to FIG. 2, a simplified exemplary block diagram of a computational unit suitable for use with the processor 10. In one embodiment, FIG. 2 could operate as the floating-point unit 16, while in other embodiments FIG. 2 could illustrate the integer unit 18.

In operation, the decode unit 24 decodes the incoming operation-codes (opcodes) to be dispatched for the computations or processing. The decode unit 24 is responsible for the general decoding of instructions (e.g., x86 instructions and extensions thereof) and how the delivered opcodes may change from the instruction. The decode unit 24 will also pass on physical register numbers (PRNs) from a available list of PRNs (often referred to as the Free List (FL)) to the rename unit 28.

The rename unit 28 maps logical register numbers (LRNs) to the physical register numbers (PRNs) prior to scheduling and execution. According to various embodiments of the present disclosure, the rename unit 28 can be utilized to rename or remap logical registers in a manner that eliminates the need to store known data values in a physical register. In one embodiment, this is implemented with a register mapping table stored in the rename unit 28. According to the present disclosure, renaming or remapping registers saves operational cycles and power, as well as decreases latency.

The scheduler 30 contains a scheduler queue and associated issue logic. As its name implies, the scheduler 30 is responsible for determining which opcodes are passed to execution units and in what order. In one embodiment, the scheduler 30 accepts renamed opcodes from rename unit 28 and stores them in the scheduler 30 until they are eligible to be selected by the scheduler to issue to one of the execution pipes.

The register file control 32 holds the physical registers. The physical register numbers and their associated valid bits arrive from the scheduler 30. Source operands are read out of the physical registers and results written back into the physical registers. In one embodiment, the register file control 32 also check for parity errors on all operands before the opcodes are delivered to the execution units. In a multi-pipelined (super-scalar) architecture, an opcode (with any data) would be issued for each execution pipe.

The execute unit(s) 34 may be embodied as any generation purpose or specialized execution architecture as desired for a particular processor. In one embodiment the execution unit may be realized as a single instruction multiple data (SIMD) arithmetic logic unit (ALU). In another embodiment, dual or multiple SIMD ALUs could be employed for super-scalar and/or multi-threaded embodiments, which operate to produce results and any exception bits generated during execution.

In one embodiment, after an opcode has been executed, the instruction can be retired so that the state of the floating-point unit 16 or integer unit 18 can be updated with a self-consistent, non-speculative architected state consistent with the serial execution of the program. The retire unit 36 maintains an in-order list of all opcodes in process in the floating-point unit 16 (or integer unit 18 as the case may be) that have passed the rename 28 stage and have not yet been committed by to the architectural state. The retire unit 36 is responsible for committing all the floating-point unit 16 or integer unit 18 architectural states upon retirement of an opcode.

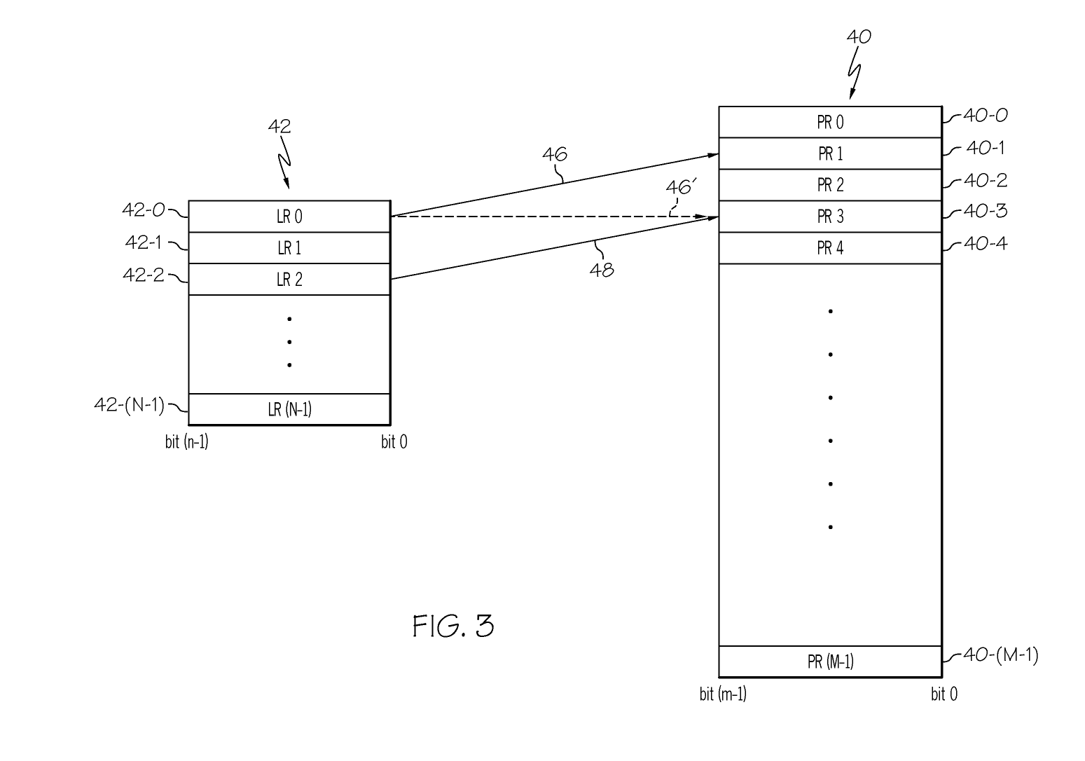

Referring now to FIG. 3, there is shown an illustration of physical registers 40 available for use during execution of an instruction (be it floating-point or integer). In one embodiment, the physical registers 40 reside in the register file control unit (32 in FIG. 2) and are organized in one or more address blocks for reading and writing operations. The various physical registers, 40-0, 40-2, 40-3 through 40-(M−1), are limited in number and are committed to a particular use for so long as necessary for the performance of an instruction. The physical registers 40 are known as “wide” registers as they contain a large number of bits (bit 0 through bit (m−1)), which in various embodiments may be 64 bits, 128 bits or 256 bits. At the conclusion (retirement) of the instruction, any available physical registers (such as those reclaimed from old, now obsolete mappings) are returned to a “free list” indicating that they are available for use by another instruction.

Also shown in FIG. 3 is a register mapping table 42 that maps the logical (or architected) registers (LR 0 through LR (N−1) to the physical registers 40. The logical registers may reside or be distributed through the processor 10 (or computational unit 16 or 18) as desired in any particular architecture. In one embodiment, the register mapping table 44 resides in the rename unit (28 in FIG. 2) so that the mappings of architected or logical register to the physical registers 40 can be changed by renaming or changing the mapping as will be more completely described below. In the register mapping table 42, the registers 42-0 through 42-(N−1) are known as “narrow” registers as they have few bits compared to the physical registers 40. Generally, the value N (the number of registers) of the register mapping table 42 corresponds to the number of logical registers (N in this example) and have a sufficient number of bits (n) to map (or point to) the physical registers 40. For example, if n=8, then the register mapping table 42 could point to 256 physical registers (in binary).

Conventionally, to execute a move instruction, one physical register is mapped as a source register and the move destination is mapped to a second physical register that will receive and store the value of the source register until needed for further processing. This approach requires the move to be scheduled within the floating-point or integer unit, which consumes a scheduler slot that could be used for other instructions. Moreover, power is consumed for both the read and write operations necessary to accomplish the move operation, which is wasteful of energy.

Instead, embodiments of the present disclosure simply remaps (or rename) the association of the logical registers to the physical registers allowing more than one logical register to point to the same physical register. In that way, the source and destination become the same physical register, which efficiently effects a move operation in essentially zero cycles of processor latency and with much less power.

Referring again to FIG. 3, consider that a move instruction has been decoded (in the decoder 24 of FIG. 2) and physical register 1 (PR 1) 40-1 has been mapped by the rename unit 28 to logical register 0 (LR 0) by remapping table register 42-0 (indicated by arrow 46), while physical register 3 (PR 3) 40-3 has been mapped to logical register 2 (LR 2) by remapping table register 42-2 (indicated by arrow 48). Rather than actually move the value of PR 3 to PR 1, the present disclosure contemplates remapping (renaming) the source register as the destination register without actually moving the data (indicated by arrow 46′). All future references to either logical register 0 (LR 0) or logical register 2 (LR 2) will map (or point) to the same physical register (PR 3) creating the same operational effect of having performed a move operation. That is, the processor will process any instruction referencing either the source logical register or destination logical register using the value stored in the commonly mapped physical register. This increases throughput, reduces latency for other operations and saves power. That is, the move instruction of the present disclosure has an apparent latency of zero cycles. For floating-point or integer computations requiring a number of move instructions, the power savings and performance improvement can be substantial.

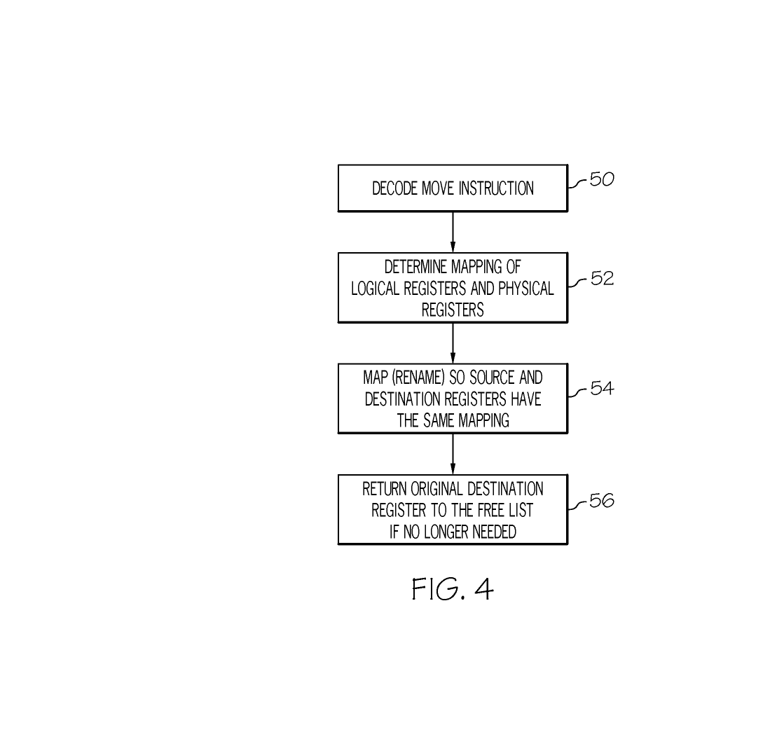

Referring now to FIG. 4, a flow diagram is shown illustrating the steps followed by various embodiments of the present disclosure for the processor 10, the floating-point unit 16, the integer unit 18 or any other unit 22 of the processor 10 that performs move instructions using a limited number of physical registers. In step 50, a determination is made that a move instruction is required. In one embodiment, this is determined in the decode stage 24 (see FIG. 2), however, the determination can be made at any convenient location prior to the scheduler 30 in order to achieve the full benefits of the present disclosure. Next, step 52 determines the source and destination register mapping by the mapping table residing in the rename unit 28. Step 54 remaps the logical registers and physical registers as required so that the source and destination point to the same physical register. All future reference to either logical registers will actually read the value in the now common physical register mapping as if as a conventional move operation had been scheduled and executed. Finally, in the event that other instructions don't require the “unmapped” physical register (PR 1 in the example of FIG. 3) it can be returned to the free list (step 56). In this way, physical registers can be made available much more rapidly than in previous move instructions in processor architectures. This saves both operational cycles and power consumption by not wasting time and energy reading and writing a register value.

Various processor-based devices may advantageously use the processor (or computational unit) of the present disclosure, including laptop computers, digital books, printers, scanners, standard or high-definition televisions or monitors and standard or high-definition set-top boxes for satellite or cable programming reception. In each example, any other circuitry necessary for the implementation of the processor-based device would be added by the respective manufacturer. The above listing of processor-based devices is merely exemplary and not intended to be a limitation on the number or types of processor-based devices that may advantageously use the processor (or computational unit) of the present disclosure.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method, comprising:
determining a mapping of a logical source register and a logical destination register to physical registers of a processor responsive to a move instruction; and
remapping the logical destination register to the same physical register mapping as the logical source register to affect an equivalent of the move instruction.

2. The method of claim 1, which includes processing via the processor any instruction referencing the logical source register or the logical destination register with a value stored in the physical register.

3. The method of claim 1, which includes making the physical destination register available for further use following the remapping.

4. A method, comprising:
determining a mapping of a first logical register to a first physical register of a processor and a second logical register to a second physical register of the processor responsive to a move instruction; and
remapping the first and second logical registers to a common physical register to affect an equivalent of the move instruction.

5. The method of claim 4, which includes processing via the processor any instruction referencing the first and second logical registers with a value stored in the physical register.

6. The method of claim 4, which includes making the second physical register available for further use following the remapping.

7. The method of claim 4, wherein processing further comprises processing floating-point instructions within a floating-point unit of the processor.

8. The method of claim 4, wherein processing further comprises processing integer instructions within an integer unit of the processor.

9. A method, comprising:
decoding a move instruction in a processor having a plurality of physical registers available for storing values, the plurality of physical registers including a first physical register and a second physical register;
responsive to decoding the move instruction, determining a mapping of a source logical register to the first physical register and a destination logical register to the second physical register;
remapping the destination logical register to have the same physical register mapping as the source logical register;
making the second physical register available for further use following the remapping; and
thereafter, processing via the processor any instruction referencing either the source logical register or destination logical register using the value stored in the mapped physical register.

10. The method of claim 9, wherein processing further comprises processing floating-point instructions within a floating-point unit of the processor.

11. The method of claim 9, wherein processing further comprises processing integer instructions within an integer unit of the processor.

12. A processor, comprising:
a plurality of physical registers mapped to a plurality of logical registers, the plurality of logical registers including a source logical register and a destination logical register; and
a renaming unit for remapping the destination logical register to the same physical register mapping as the source logical register in response to a move instruction;
wherein, the move instruction is effectively executed without moving data between physical registers.

13. The processor of claim 12, which includes an integer computational unit for performing integer computations.

14. The processor of claim 12, which includes other circuitry to implement one of the group of processor-based devices consisting of: a computer; a digital book; a printer; a scanner; a television or a set-top box.
Consider dependent claims directed to one or both of the remapping table or more specifics on how a move instruction is handled by the processor as a result of the remapping.

15. A processor, comprising:
a plurality of physical registers mapped to a plurality of logical registers, the plurality of logical registers including a source logical register and a destination logical register associated with a move instruction;
a renaming unit for remapping the destination logical register to a common physical register mapping as the source logical register; and
scheduling and execution units for performing computations using a value stored in the common physical register;
wherein, the move instruction is effectively executed without moving data between physical registers.

16. The processor having a computational unit of claim 15, which includes other circuitry to implement one of the group of processor-based devices consisting of: a computer; a digital book; a printer; a scanner; a television or a set-top box.
